(19) United States
(12) Patent Application Publication
(10) Pub. No.: US 2012/0056797 A1
(43) Pub. Date: Mar. 8, 2012

(54) FREQUENCY-TUNABLE ANTENNA

(75) Inventors: Huang-Tse Peng, Jhonghe City (TW); Kuo-Jen Lai, Jhonghe City (TW)

(73) Assignee: ARIMA COMMUNICATIONS CO., LTD., Jhonghe City (TW)

(21) Appl. No.: 12/952,450

(22) Filed: Nov. 23, 2010

(30) Foreign Application Priority Data
Sep. 3, 2010 (TW) 099129800

(51) Int. Cl. H01Q 1/50

(52) U.S. Cl. 343/857

(57) ABSTRACT

A frequency-tunable antenna includes a radiating element, a feeding terminal, a first ground terminal and a second ground terminal. The radiating element includes a first segment, a turning segment and a second segment. The turning segment is interconnected between the first segment and the second segment. The feeding terminal is disposed at the first segment of the radiating element, and electrically connected with the radiating element and the circuit substrate. The first ground terminal disposed beside the feeding terminal. The second ground terminal is arranged between the first ground terminal and the turning segment of the radiating element. A radio frequency switch mounted on the circuit substrate is selectively connected with either the first ground terminal or the second ground terminal, so that the frequency-tunable antenna transmits and receives a wireless signal in first frequency band or a second frequency band.

### FIELD OF THE INVENTION

The present invention relates to an antenna, and more particularly to a frequency-tunable antenna for use in a wireless communication device.

### BACKGROUND OF THE INVENTION

In recent years, the development of the wireless communication industry is vigorous. The wireless communication devices such as mobile phones or personal digital assistants (PDAs) have become indispensable commodities. An antenna generally plays an important role for transmitting and receiving wireless signals in a wireless communication device. Therefore, the operating characteristics of the antenna have a direct impact on the transmission and receiving quality of the wireless communication device.

Generally, the antenna of the portable wireless communication device is roughly classified into two categories, including an external type antenna and an embedded type antenna. The external type antenna is commonly shaped as a helical antenna, and the embedded type antenna is commonly shaped as a planar inverted-F antenna (PIFA). Since the helical antenna is exposed to the exterior casing of the wireless communication device, the helical antenna is readily damaged and the communication quality is deteriorated. A planar inverted-F antenna has a simple structure and a small size and is easily integrated with an electronic circuit. Nowadays, the planar inverted-F antenna has been widely employed in a variety of wireless communication devices.

As known, a well-designed antenna should have a low return loss and a high operating bandwidth. In order to allow the wireless communication device to receive wireless signals with great convenience and high quality, the current wireless communication devices have been enhanced by increasing the number of antennas or enlarge the antenna. Consequently, the wireless communication device may transmit and receive wireless signals with a larger bandwidth or multiple frequency bands. However, with the integration of circuit elements and the miniaturization of the wireless communication device, the conventional design method fails to meet the user's requirements.

For allowing the antenna to transmit and receive wireless signals in the limited receiving space with a larger bandwidth and a better transmission quality, the structure of the antenna needs to be modified. FIG. 1 is a schematic view illustrating the structure of a conventional antenna. As shown in FIG. 1, the conventional antenna 1 is a planar inverted-F antenna. The antenna 1 comprises a radiating element 11, a feeding terminal 12 and a ground terminal 13. The radiating element 11 comprises a first segment 11a, a turning segment 11b and a second segment 11c. The first segment 11a and the second segment 11c are substantially parallel with each other. The turning segment 11b is interconnected between the first segment 11a and the second segment 11c. The turning segment 11b is substantially perpendicular to the first segment 11a and the second segment 11c. That is, the radiating element 11 is substantially shaped like a right hand square bracket “]”.

As shown in FIG. 1, the feeding terminal 12 and the ground terminal 13 are disposed at a distal region of the first segment 11a of the radiating element 11. In addition, the ground terminal 13 is arranged between the feeding terminal 12 and the turning segment 11b. Via the feeding terminal 12, the radio frequency (RF) signal emitted by a RF circuit (not shown) may be fed to the antenna 1. Furthermore, the RF signal sensed by the antenna 1 may be transmitted to the RF circuits via the feeding terminal 12. In such manner, a resonant mode is created to transmit and receive wireless signals in a low frequency band located at, for example, the 824˜894 MHz of the GSM850 system (Global System for Mobile Communications 850).

However, the contemporary wireless communication system not only supports the GSM850 system, but also supports the GSM900 system (Global System for Mobile Communications 900). The frequency band of the GSM900 system is located at 880˜960 MHz. Since the conventional antenna 1 is only adapted for a single frequency band application, it is obvious that the limited frequency bandwidth of the conventional antenna 1 can not be simultaneously adapted for the GSM850 system and the GSM900 system.

For obviating the drawbacks encountered from the prior art, there is a need of providing a frequency-tunable antenna applicable to different low frequency band communication systems.

### SUMMARY OF THE INVENTION

The present invention provides a frequency-tunable antenna. By allowing a frequency radio switch to be selectively connected with either a first ground terminal or a second ground terminal of the frequency-tunable antenna, the bandwidth of the frequency-tunable antenna is increased. Consequently, the frequency-tunable antenna can be simultaneously adapted for the GSM850 system and the GSM900 system.

The present invention also provides a frequency-tunable antenna for increasing the bandwidth without increasing dimension and size of the antenna, thereby improving the efficiency of antenna and reducing the power consumption of antenna.

In accordance with an aspect of the present invention, there is provided a frequency-tunable antenna disposed on a circuit substrate. The frequency-tunable antenna includes a radiating element, a feeding terminal, a first ground terminal and a second ground terminal. The radiating element includes a first segment, a turning segment and a second segment. The turning segment is interconnected between the first segment and the second segment. The feeding terminal is disposed at the first segment of the radiating element, and electrically connected with the radiating element and the circuit substrate. The first ground terminal disposed beside the feeding terminal. The second ground terminal is arranged between the first ground terminal and the turning segment of the radiating element. A radio frequency switch mounted on the circuit substrate is selectively connected with either the first ground terminal or the second ground terminal, so that the frequency-tunable antenna transmits and receives a wireless signal in first frequency band or a second frequency band.

In an embodiment, the first frequency band includes a frequency band of a GSM850 system.

In an embodiment, the second frequency band includes a frequency band of a GSM900 system.

In an embodiment, the frequency-tunable antenna is mounted on an antenna carrier of the circuit substrate.

In an embodiment, the feeding terminal is connected with a first end of the first segment of the radiating element.

In an embodiment, the first segment and the second segment of the radiating element are substantially parallel with each other.

In an embodiment, the turning segment is substantially perpendicular to the first segment and the second segment.

In an embodiment, the widths of the first segment, the turning segment and the second segment of the radiating element are substantially identical.

In an embodiment, the frequency-tunable antenna is installed in a wireless communication device.

In an embodiment, the wireless communication device is a mobile phone, a personal digital assistant (PDA), a Bluetooth communication device, a Global Positioning System (GPS) device or a portable computer.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating the structure of a conventional antenna;

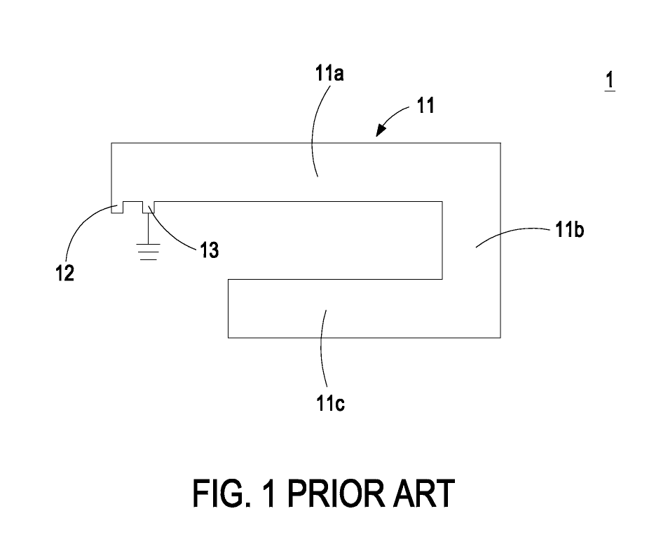

FIG. 2 is a schematic view illustrating the structure of a frequency-tunable antenna according to an embodiment of the present invention;

FIG. 3 is a schematic view illustrating the frequency-tunable antenna mounted on an antenna carrier of a circuit substrate according to an embodiment of the present invention; and

FIG. 4 is a plot illustrating the standing-wave ratio versus frequency relationship of the frequency-tunable antenna of FIG. 2.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

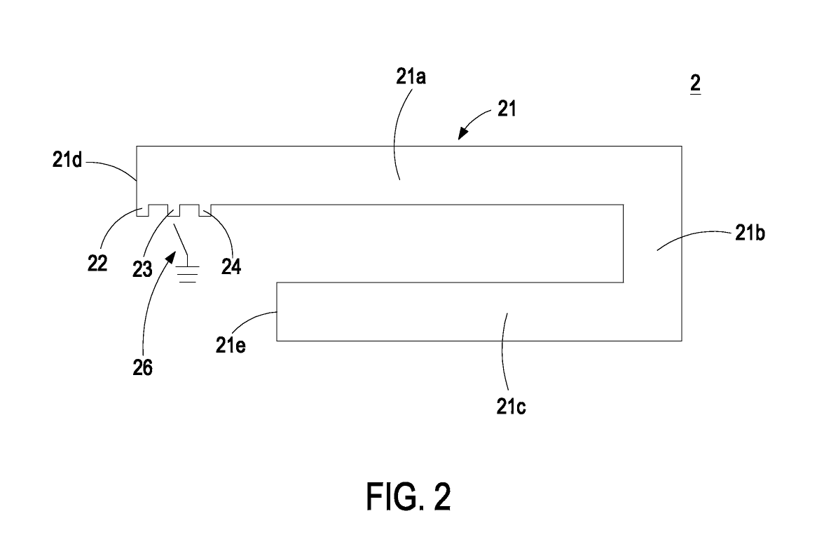

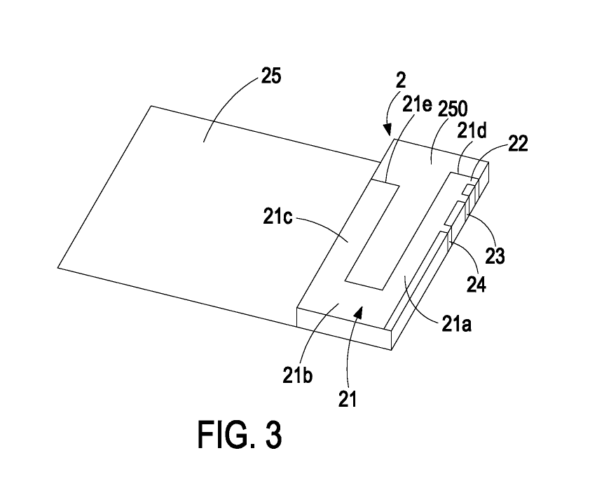

FIG. 2 is a schematic view illustrating the structure of a frequency-tunable antenna according to an embodiment of the present invention. FIG. 3 is a schematic view illustrating the frequency-tunable antenna mounted on an antenna carrier of a circuit substrate according to an embodiment of the present invention. Please refer to FIG. 2 and FIG. 3. The frequency-tunable antenna 2 is a planar inverted-F antenna. The frequency-tunable antenna 2 is mounted on an antenna carrier 250 of a circuit substrate 25 of a wireless communication device (not shown). An example of the wireless communication device includes but is not limited to a mobile phone, a personal digital assistant (PDA), a Bluetooth communication device, a Global Positioning System (GPS) device or a portable computer.

As shown in FIG. 2, the frequency-tunable antenna 2 comprises a radiating element 21, a feeding terminal 22, a first ground terminal 23 and a second ground terminal 24. The radiating element 21 comprises a first segment 21a, a turning segment 21b and a second segment 21c. The widths of the first segment 21a, the turning segment 21b and the second segment 21c of the radiating element 21 are substantially identical. The first segment 21a and the second segment 21c are substantially parallel with each other. In some embodiments, the first segment 21a is longer than the second segment 21c. The turning segment 21b is interconnected between the first segment 21a and the second segment 21c. The turning segment 21b is substantially perpendicular to the first segment 21a and the second segment 21c. That is, the radiating element 21 is substantially shaped like a right hand square bracket “]”.

Please refer to FIG. 2 again. The feeding terminal 22, the first ground terminal 23 and the second ground terminal 24 are disposed at a distal region of the first segment 21a of the radiating element 21. The feeding terminal 22 is connected with a first end 21d of the first segment 21a. The first ground terminal 23 is disposed beside the feeding terminal 22, and arranged between feeding terminal 22 and the second ground terminal 24. The second ground terminal 24 is arranged between the first ground terminal 23 and the turning segment 21b of the radiating element 21.

Please refer to FIG. 3. The antenna carrier 250 is disposed at a side of the circuit substrate 25. In addition, the frequency-tunable antenna 2 is mounted on the circuit substrate 25. The feeding terminal 22 and the radiating element 21 are electrically connected with the circuit substrate 25. A first end of the first ground terminal 23 and a first end of the second ground terminal 24 are electrically connected with the radiating element 21, and either a second end of the first ground terminal 23 or a second end of the second ground terminal 24 is selectively connected with a radio frequency switch 26 (see FIG. 2). Moreover, the radio frequency switch 26 is further connected with a radio frequency circuit (not shown) of the circuit substrate 25. By automatically or manually switching the radio frequency switch 26, the radio frequency circuit is selectively connected with either the first ground terminal 23 or the second ground terminal 24. Via the feeding terminal 22, the radio frequency (RF) signal emitted by the radio frequency circuit of the circuit substrate 25 may be fed to the frequency-tunable antenna 2. The RF signal is successively transmitted through the first segment 21a, the turning segment 21b and the second segment 21c to a second end 21e of the second segment 21c. Then, through the second segment 21c, the turning segment 21b and the first segment 21a, the RF signal is successively returned back from the second segment 21c to either the first ground terminal 23 or the second ground terminal 24. Consequently, a resonant mode is created to transmit and receive wireless signals in a low frequency band. In other words, when the radio frequency switch 26 is selectively connected with either the first ground terminal 23 or the second ground terminal 24, the frequency-tunable antenna 2 may transmit and receive a wireless signal in a first frequency band or a second frequency band.

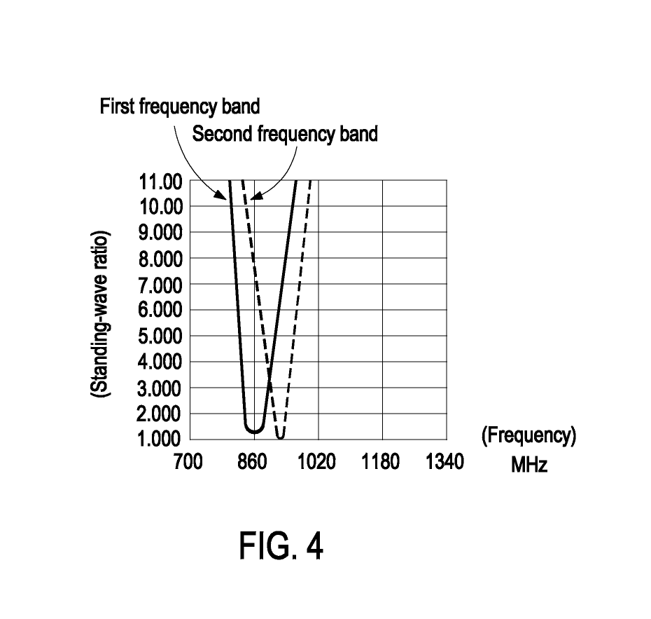

FIG. 4 is a plot illustrating the standing-wave ratio versus frequency relationship of the frequency-tunable antenna of FIG. 2. In a case that the radio frequency switch 26 (see FIG. 2) is electrically connected with the first ground terminal 23, the radiating element 21 is configured to provide a longer resonant current path. As a consequence, a resonant mode is created to transmit and receive wireless signals in a low frequency band (e.g. the first frequency band located at 824˜894 MHz). Whereas, in a case that the radio frequency switch 26 is electrically connected with the second ground terminal 24, the radiating element 21 is configured to provide a shorter resonant current path. As a consequence, a resonant mode is created to transmit and receive wireless signals in another low frequency band (e.g. the second frequency band located at 880˜960 MHz). That is, the first frequency band indicates the frequency band of the GSM850 system located at 880˜960 MHz, and the second frequency band indicates the frequency band of the GSM900 system located at 880˜960 MHz. By automatically or manually switching the radio frequency switch 26, the radio frequency circuit is selectively connected with either the first ground terminal 23 or the second ground terminal 24. Consequently, the frequency-tunable antenna may transmit and receive wireless signals in either the first frequency band (GSM850 system) or the second frequency band (GSM900 system). In other words, the frequency-tunable antenna 2 may be operated in different bandwidths of the low frequency band.

On the other hand, the frequency-tunable antenna of the present invention can increase the bandwidth of the antenna without considerably increasing volume and size of the antenna. Since the frequency-tunable antenna of the present invention has a common feeding terminal cooperating with the first ground terminal and the second ground terminal, the configuration of the frequency-tunable antenna is very simple.

From the above description, the bandwidth of the frequency-tunable antenna of the present invention is increased by allowing a frequency radio switch to be selectively connected with either a first ground terminal or a second ground terminal of the frequency-tunable antenna. Consequently, the frequency-tunable antenna can be simultaneously adapted for the GSM850 system and the GSM900 system. On the other hand, the use of the frequency-tunable antenna of the present invention may increase the bandwidth without increasing dimension and size of the antenna, thereby improving the efficiency of antenna and reducing the power consumption of antenna.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A frequency-tunable antenna disposed on a circuit substrate, said frequency-tunable antenna comprising:
a radiating element comprising a first segment, a turning segment and a second segment, wherein said turning segment is interconnected between said first segment and said second segment;
a feeding terminal disposed at said first segment of said radiating element, and connected with said radiating element and said circuit substrate;
a first ground terminal disposed beside said feeding terminal; and
a second ground terminal arranged between said first ground terminal and said turning segment of said radiating element,
wherein a radio frequency switch mounted on said circuit substrate is selectively connected with either said first ground terminal or said second ground terminal, so that said frequency-tunable antenna transmits and receives a wireless signal in a first frequency band or a second frequency band.

2. The frequency-tunable antenna according to claim 1 wherein said first frequency band includes a frequency band of a GSM850 system.

3. The frequency-tunable antenna according to claim 1 wherein said second frequency band includes a frequency band of a GSM900 system.

4. The frequency-tunable antenna according to claim 1 wherein said frequency-tunable antenna is mounted on an antenna carrier of said circuit substrate.

5. The frequency-tunable antenna according to claim 1 wherein said feeding terminal is connected with a first end of said first segment of said radiating element.

6. The frequency-tunable antenna according to claim 1 wherein said first segment and said second segment of said radiating element are substantially parallel with each other.

7. The frequency-tunable antenna according to claim 1 wherein said turning segment is substantially perpendicular to said first segment and said second segment.

8. The frequency-tunable antenna according to claim 1 wherein the widths of said first segment, said turning segment and said second segment of said radiating element are substantially identical.

9. The frequency-tunable antenna according to claim 1 wherein said frequency-tunable antenna is installed in a wireless communication device.

10. The frequency-tunable antenna according to claim 9 wherein said wireless communication device is a mobile phone, a personal digital assistant (PDA), a Bluetooth communication device, a Global Positioning System (GPS) device or a portable computer.
